(19) United States
(12) Patent Application Publication
(10) Pub. No.: US 2002/0179123 A1
(43) Pub. Date: Dec. 5, 2002

(54) Fluidized cleaning and scarification apparatus and method

(76) Inventors: Charles Toward, McDonald, PA (US); Keith Eberhardt, Aliquippa, PA (US); Patrick M. Winkler, Alequippa, PA (US)

Correspondence Address: Gerald J. Iwanejko, Jr., Cohen & Grigsby, P.C., 15th Floor, 11 Stanwix Street, Pittsburgh, PA, 15222, US

(21) Appl. No.: 09/871,056

(22) Filed: May 31, 2001

(51) Int. Cl. B08B 3/02; B08B 9/093

(52) U.S. Cl. 134/34; 134/172; 134/22.18; 134/167 R; 134/58 R

(57) ABSTRACT

The present invention provides an apparatus and method for fluidized cleaning or scarification of a surface wherein the apparatus comprises a moveable carriage for mounting an assembly which conveys an adjustable pressurized treatment fluid, preferably water, that contacts the treated surface.

### FIELD OF THE INVENTION

This invention relates to an apparatus and method for fluidized cleaning and scarification of a surface, and particularly to an automated device and method used to clean and/or scarify interior or exterior surfaces using an adjustable pressurized water jet.

### BACKGROUND OF THE INVENTION

The present invention arose from the need to provide an automated apparatus and method for fluidized cleaning and scarification of structural surfaces in industrial applications, particularly construction projects involving conduits, tunnels, aqueducts, interior and exterior building surfaces, bridge support structures and the like.

Structural surfaces are often finished by applying such materials as concrete, shockcrete, mortar, urethanes, epoxies and similar compounds. In order to maintain, repair and preserve such surfaces, it is often necessary to apply a fluidized material such as water to clean and/or remove a layer of material from the surface. Additionally, noncoated stone, brick or metal surfaces are subject to the need for such cleaning and preservation. In the concrete restoration business, scarification is generally considered removal of roughly ½” of concrete, and involves removing the top portion of the concrete surface to expose a rough interior profile which permits the bonding of new materials. The completion of scarification, however, does not provide a finished surface; rather, it is a step which permits the proper application of a new material which provides the finished surface layer. As the scarification process is being accomplished, the exposed surface will be cleaned in addition to removal of the amount of material necessary to provide the rough bonding profile for the new surface layer. As such, a two-fold goal is achieved; first, the removal of the deteriorated surface layer, plus the creation of a new surface profile to allow bonding of new coating materials.

Prior to the present invention, the conventional method for accomplishing this process was by manual application of the treatment fluid, such as with hand-held water lances. Use of such a manual process can involve an unproductive use of manpower, so the present invention was developed using automated equipment to produce the large treatment fluid volumes in combination with the fluid application speed and frequency needed to clean and scarify large surface areas covering extensive amounts of space in industrial applications. Due to the variable nature of the amount, frequency and speed of treatment fluid application, the present invention can be used for cleaning, scarification and surface material removal of significant depths.

Accordingly, it is an object of the present invention to provide an apparatus and method for fluidized cleaning and scarification of a surface.

It is another object of the present invention to provide an automated apparatus and method for fluidized cleaning and scarification of structural surfaces in industrial applications It is another object of the present invention to provide an automated apparatus and method for use in cleaning and scarification in construction projects involving conduits, tunnels, aqueducts, interior and exterior building surfaces, bridge support structures and the like.

It is another object of the present invention to provide an automated apparatus and method for use in cleaning and scarification that permits a variable amount, volume, rate, frequency and speed of treatment fluid application in order to clean and scarify large surface areas covering extensive amounts of space.

It is another object of the present invention to provide an automated device and method used to clean and/or scarify interior or exterior surfaces using an adjustable pressurized water jet.

### SUMMARY OF THE INVENTION

The present invention provides an apparatus and method for fluidized cleaning or scarification of a surface wherein the apparatus comprises a moveable carriage for mounting an assembly which conveys an adjustable pressurized treatment fluid, preferably water, that contacts the treated surface.

In embodiments of the invention designed for cleaning and scarifying curved surfaces of conduits and tunnels, the treatment fluid conveyor assembly comprises a moveable nozzled swing arm which preferably rotates about a central axis with an adjustable counterweight mounted opposite thereto for balancing the rotation of the swing arm. The swing arm is fully adjustable as to speed, amount and frequency of movement and can be operated in a continuous or periodic reversible manner over a full or limited rotary arc in such fashion as to permit stopping and restarting the swing arm and nozzle at any point along their travel.

The treatment fluid is conveyed through a single or multiple port spray nozzle mounted to the end of the swing arm wherein the nozzle is fully moveable and adjustable as to the amount, volume, rate, frequency and/or speed at which the treatment fluid is delivered. The nozzle receives treatment fluid from a source external to the apparatus which directs the fluid to the nozzle through a swivel which allows the nozzle to rotate around the longitudinal axis of the swing arm, which itself moves around its central axis in an orientation perpendicular to the rotation of the nozzle. The rotation of the nozzle is controlled by a rotary drive that receives a source of power to accomplish the rotation that is operated independently of delivery of the treatment fluid. The movement of the swing arm is preferably controlled by a hydraulic motor which is operated independently from the rotating nozzle. The carriage, swing arm and nozzle movements and functions can be made automatic or can be remotely and/or manually controlled by the operator (including an override of any automatic functions), and are capable of infinitely variable adjustment while the machine is in use.

In embodiments of the invention designed for cleaning and scarifying three-dimensional surfaces such as bridge structural beams, the design of the nozzle preferably remains the same as described for the curved surface embodiment, but the rotary swing arm is replaced with a boom that is capable of telescopic three-dimensional movement to permit the nozzle to extend into areas which are difficult to access, while the nozzle itself is mounted to the boom in a manner to permit three-dimensional telescopic movement of the nozzle independent of boom movement. The positioning of the boom and nozzle can be adjusted independently of each other using pitch, yawl, roll and thrust functions to permit a complete three dimensional range of movement for cleaning or scarifying any surface. Additionally, movement of the boom and nozzle is fully adjustable so as to permit operation in a continuous or periodic reversible unidirectional or multidirectional manner over a full or limited range in such fashion as to permit stopping and restarting the boom and nozzle at any point along their travel. The boom movement is again preferably controlled hydraulically and operated independently from the nozzle rotation. The carriage, boom and nozzle movements and functions can again be made automatic or can be remotely and/or manually controlled by the operator (including an override any of automatic functions), and are capable of infinitely variable adjustment while the machine is in use.

In embodiments of the invention designed for cleaning and scarifying flat surfaces, the design of the nozzle again preferably remains the same as described for the curved and threedimensional surface embodiments, but the rotary swing arm is replaced with a mast that permits linear movement of the nozzle to traverse the surface in one dimension of the surface plane while movement of the carriage permits the nozzle to move in the other plane dimension. The orientation of the mast can be adjusted to permit cleaning or scarifying horizontal or vertical surfaces and its movement is fully adjustable so as to permit operation in a continuous or periodic reversible manner over a full or limited range in such fashion as to permit stopping and restarting the mast and nozzle at any point along their travel. The mast movement is again preferably controlled hydraulically and operated independently from the nozzle rotation. The carriage, mast and nozzle movements and functions can again be made automatic or can be remotely and/or manually controlled by the operator (including an override any of automatic functions), and are capable of infinitely variable adjustment while the machine is in use.

These and other advantages of the invention will become apparent from a perusal of the following detailed description of the presently preferred embodiments of the invention taken in connection with the accompanying drawings.

### BRIEF DESCRIPTION OF THE DETAILED DRAWINGS

FIG. (1) shows an end view of an embodiment of the fluidized cleaning and scarification apparatus of the present invention as used in a tunnel or conduit structure.

FIG. (2) shows a side perspective view of an embodiment of the fluidized cleaning and scarification apparatus of the present invention as configured for use with curved surfaces such as tunnel or conduit structures.

FIG. (2A) shows a side perspective view of an embodiment of the fluidized cleaning and scarification apparatus of the present invention as configured for use with curved surfaces such as tunnel or conduit structures and including a camming mechanism for allowing the nozzle to follow the contour of the surface.

FIG. (3) shows a perspective view of an embodiment of the fluidized cleaning and scarification apparatus of the present invention as configured for use with three-dimensional surfaces such as bridge structural beams.

FIGS. (4) and (4A) show views of an embodiment of the fluidized cleaning and scarification apparatus of the present invention as configured for use with flat surfaces such as building walls.

### DETAILED DESCRIPTION OF THE PRESENTLY PREFERRED EMBODIMENTS

FIGS. (1) and (2) show an end view and a side perspective view, respectively, of an embodiment of the fluidized cleaning and scarification apparatus of the present invention as configured for use with curved surfaces such as tunnel or conduit structures.

This embodiment of the apparatus comprises a moveable carriage 6, in this embodiment a motorized tractor, for mounting an assembly which conveys an adjustable pressurized treatment fluid, preferably water, that contacts the treated surface. The treatment fluid conveyor assembly 10 comprises a moveable swing arm 8 with a fluid delivery nozzle 2 located at one end. The swing arm 8 moves (preferably by rotation) about a central axis with an adjustable counterweight 9 mounted opposite thereto for balancing the rotation of the swing arm 8. The swing arm 8 and nozzle 2 are fully moveable and adjustable as to speed, amount, frequency and direction of rotation 20 and can be operated in a continuous or periodic reversible manner (i.e., in a one-way or reciprocal two-way manner in the embodiment of FIG. (1) and (2)) over a full or limited rotary arc in such fashion as to permit stopping and restarting the swing arm 8 and nozzle 2 at any point along their travel.

The swing arm 8 is adjustable in length to permit the nozzle 2 to be juxtapositioned as closely as possible to the surface in order to maximize cleaning or scarifying capability and quality. The counterweight 9 is also adjustable in length to ensure that the swing arm 8 is completely balanced, thereby avoiding changes in swing arm 8 speed during rotation that can cause an irregular cleaning or scarification pattern. The adjustments are made by placing the machine in the correct position to be used and then adjusting the swing arm 8 and/or counterweight 9 position to achieve a balance, which is accomplished by adjusting the length and/or location of the axis of movement of the swing arm 8 and counterweight 9 and/or the location of the carriage 6. These adjustments can take place before machine use and can be changed depending on changing surface conditions or geometry and depending on the use to which the machine is put.

The treatment fluid is conveyed through a single or multiple port rotary spray nozzle 2 mounted to the end of the swing arm 8 wherein the nozzle 2 is fully adjustable as to the amount, volume, rate, frequency and/or speed at which the treatment fluid is delivered. The nozzle 2 receives treatment fluid from a source external to the apparatus which directs the fluid to the nozzle through a preferably high pressure swivel 3 which allows the nozzle 2 to rotate around the longitudinal axis of the swing arm 8. A counterpart swivel 3A provides the entry point for the high pressure treatment fluid into the apparatus from the external fluid source. Swing arm 8 in turn rotates around its central axis in an orientation perpendicular to the rotation of the nozzle 2.

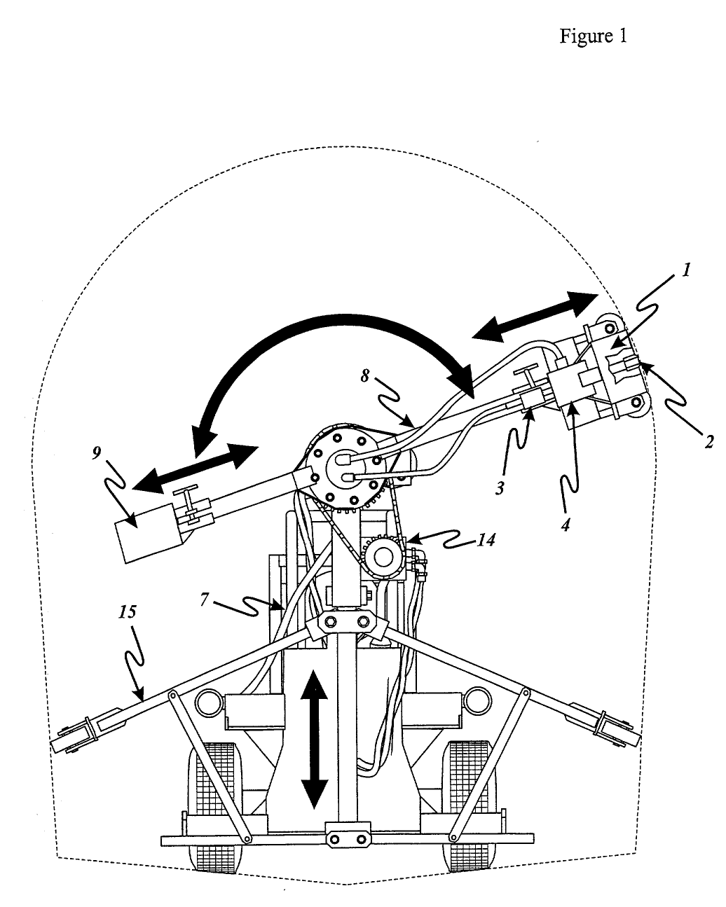

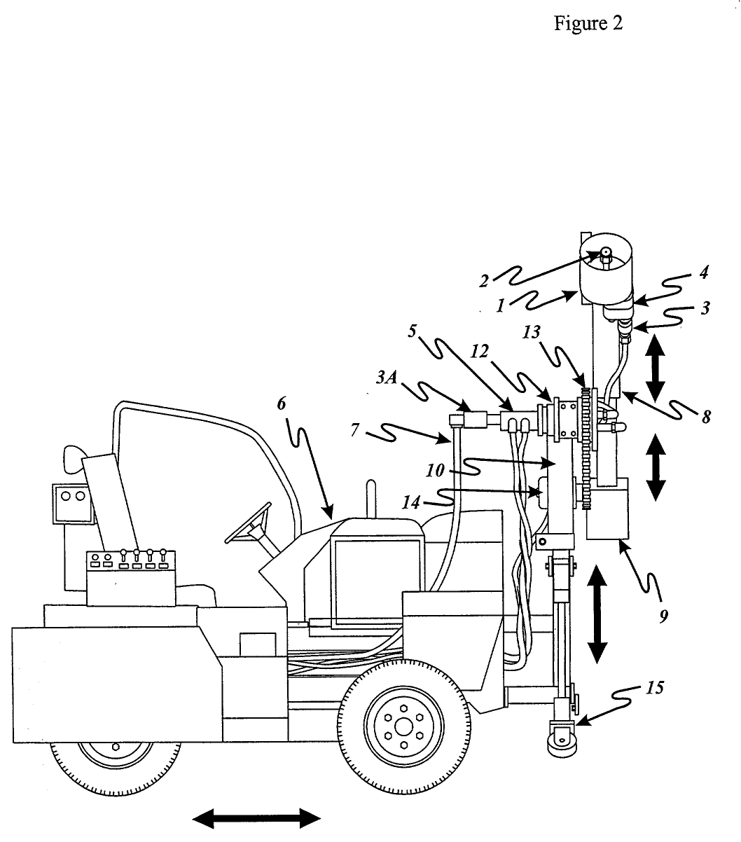

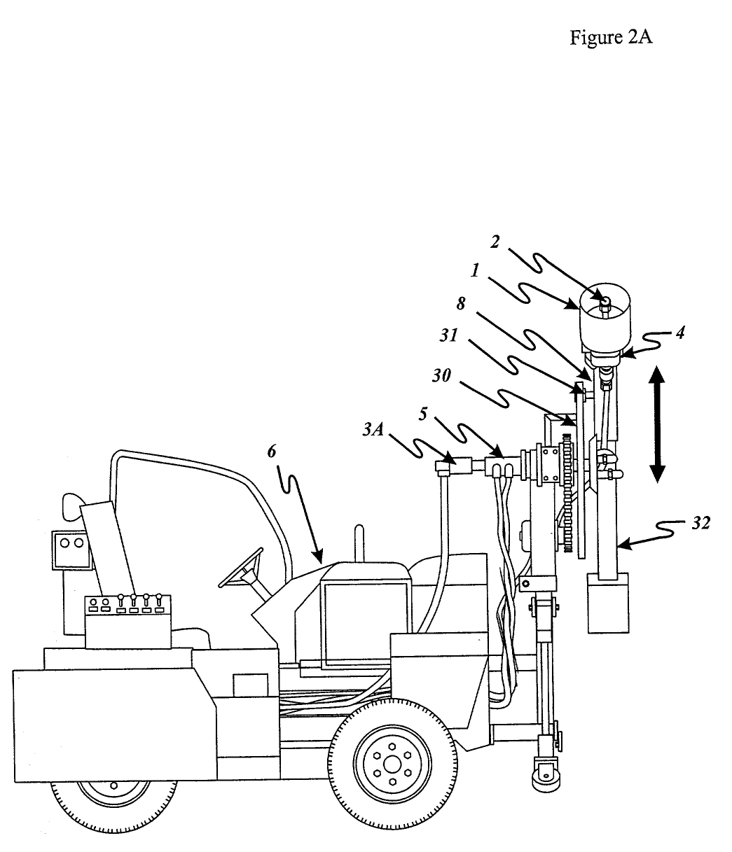

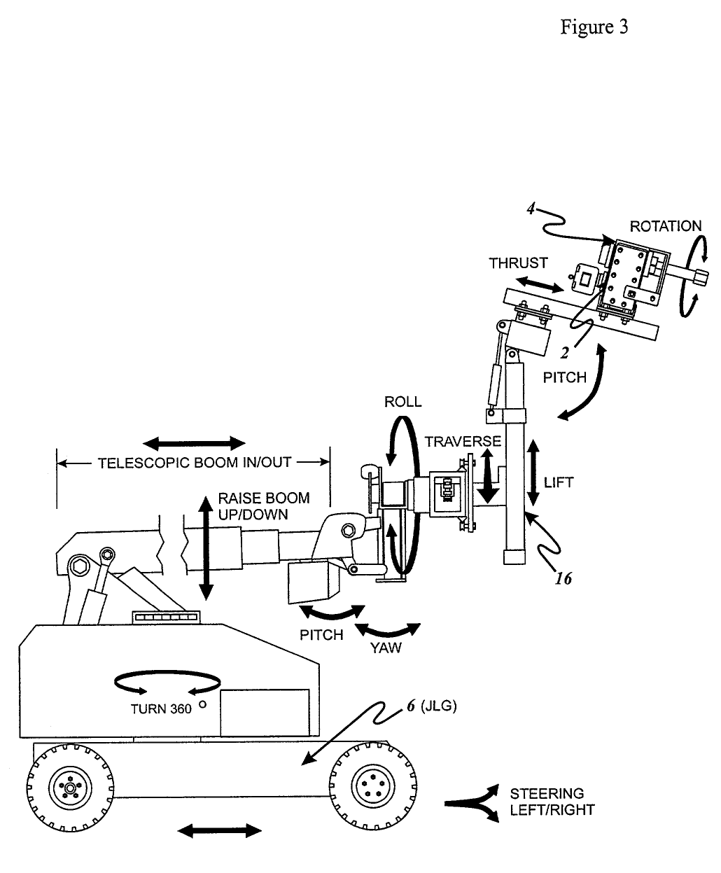

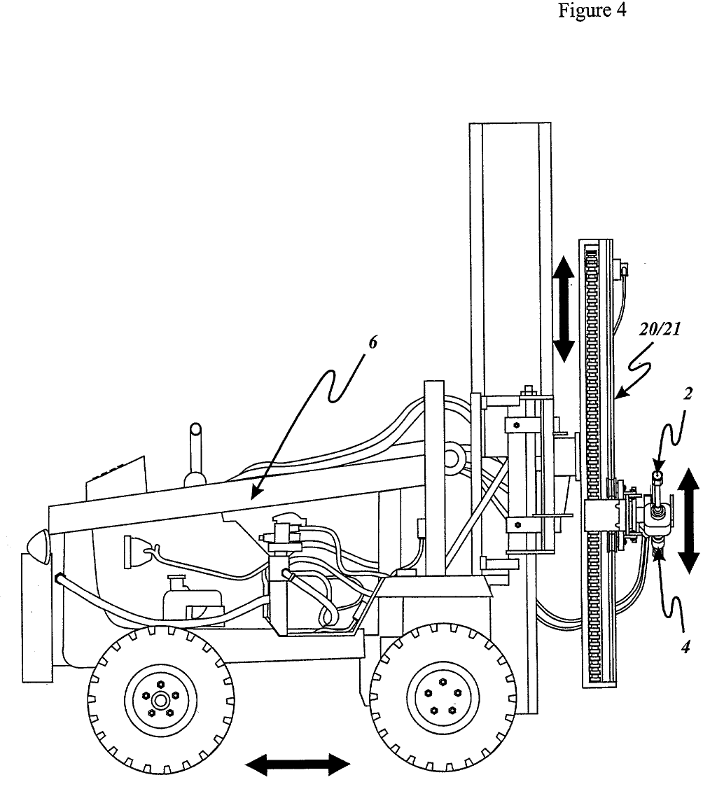

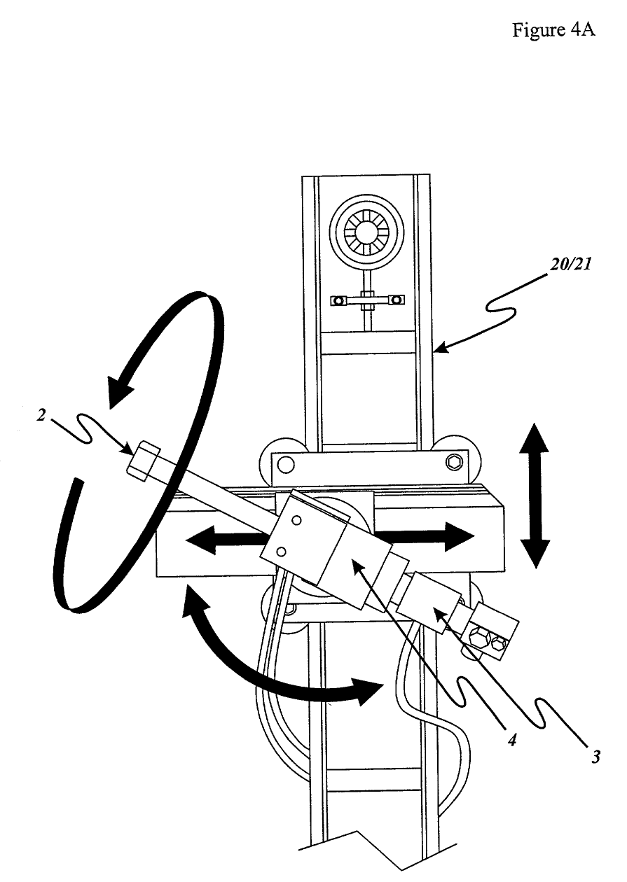

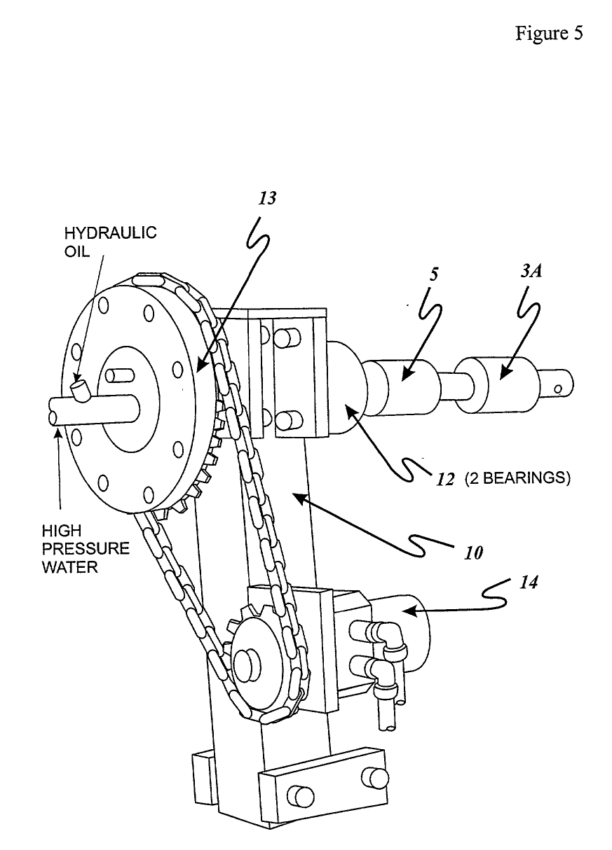

The rotation of the nozzle 2 is controlled by a rotary drive 4 that preferably receives a source of hydraulic power to accomplish the rotation which is independent of delivery of the treatment fluid. The movement of the swing arm 8 takes place within a bearing 12 and is preferably controlled by a mechanism such as a hydraulic motor 14 and gear 13 arrangement that is operated independently from the rotating nozzle 2. The hydraulic fluid (preferably oil but optionally any fluid sufficient for this use such as water) is preferably routed by hydraulic lines 7 (using diesel-run pumps located on carriage 6) through a specially designed hydraulic swivel 5 to the rotary drive 4 and hydraulic motor 14 to serve as the source of motive power for the nozzle 2 and swing arm 8, with independent delivery thereto, respectively. The motorized rotary drive 4 and hydraulic motor 14 are preferably of a conventional turbine-type design with blades that spin to turn the motor as the pressurized hydraulic fluid is routed therethrough and recirculated back to the diesel-driven pumps. Hydraulic swivel 5 is preferably a rotary swivel containing seals for either end with a high pressure tube running through the center that allows the hydraulic fluid and the treatment fluid (preferably high pressure water) to pass simultaneously through the swivel 5 (as shown in FIG. 5) as both types of fluid are routed to the swing arm 8. Swivels 3 and 3A serve as a coupling between the fixed hoses for the treatment fluid running through the swing arm 8 and the spinning parts located in the nozzle 2 and hydraulic swivel 5, respectively.

As can be seen from FIG. (1), a circular shield 1 can optionally surround the nozzle 2 to protect it from damage as well as to contain debris, while FIG. (1) shows optional “feeler arms” 15 which allow the operator to guide the apparatus next to the cleaning surface without causing the nozzle 2 to contact the surface. The head of the nozzle 2 can accommodate either a single or multijet flow pattern. A specialized multijet nozzle known as a “hydrolight” or “ultralight” head (such as that manufactured by Flow International, Inc.) can be used a cleaning head primarily on flat surfaces. Any number of fluid orifices (or “jets”), preferably between two and sixteen, can be used to maximize cleaning ability, depending on the application. Scarification is accomplished by preferably using a single jet nozzle and varying the rotational speed of the nozzle 2 and/or the frequency of movement of the swing arm 8 to determine the depth of the scarified material removal. Holding the swing arm 8 and carriage 6 stationary in one spot while rotating nozzle 2 at a slow speed allows excavation of the scarified material to a maximum extent, whereas a high rotational speed for nozzle 2 and/or high movement frequency for the swing arm 8 over the scarified area allows a minimum removal with a higher quality smoothness of the treated surface. During a given cleaning or scarification operation, fluid delivery pressure and/or volume are preferably maintained substantially constant while adjustment of nozzle 2 rotational speed and/or swing arm 8 frequency of movement determines the treatment quality, whereas fluid pressure and/or volume can be varied from operation to operation depending on the amount of cleaning and/or scarification to be accomplished and the amount of time taken to do so. For example, a smaller project may require only one pump, running at 16 gallons per minute and 35,000 pounds per square inch (psi), whereas a more extensive project may require for example two or more pumps delivering a different treatment fluid volume, or one or more pumps operating at a different pressure.

The carriage 6 can be any conventional vehicle suitable for this purpose such as a converted Bobcat Trencher. The carriage 6 preferably includes a self-contained hydraulic system to operate the various functions of the apparatus. The hydraulic system contains an engine for powering the carriage 6 in forward or reverse, and for operating the steering, brakes, and adjusting the lift mechanism for the center point of the treatment fluid conveyor assembly 10 (i.e., the axis of movement of the swing arm 8). When the apparatus is in use, the engine powers hydraulic pumps that supply fluid to the various hydraulic functions, including the rotary drive 4 and hydraulic motor 14. The carriage 6 can be set to operate in a continuous drive, or in an indexing mode whereby it 20 periodically stops and starts to allow the nozzle 2 and swing arm 8 to operate in place at a given position. These functions can be made automatic (such as through use of microprocessor or programmable logic circuit or relay logic circuit control) or can be remotely and/or manually controlled by the operator (including an override any of automatic functions). Both the movement of the swing arm 8 and the rotation of the nozzle 2 can be set and adjusted in this manner, and the nozzle 2 and swing arm 8 rotation and movement are capable of infinitely variable adjustment while the machine is in use.

FIG. (2A) shows an optional cam guide 30 that attaches to the carriage 6 with cam 31 mounted on the adjustable section 32 of the swing arm 8. Cam 31 and guide 30 allow the adjustable section 32 to move inward and outward as the swing arm 8 rotates thereby allowing the head of the nozzle 2 to follow the contour of the treated surface where the contour varies such as in a horseshoe-shaped tunnel with a flat floor. The cam 31 and guide 30 can be made to any shape to match the contour of the treated surface.

In embodiments of the invention designed for cleaning and scarifying three-dimensional surfaces such as bridge structural beams as shown for example in FIG. (3), the design of the nozzle 2 preferably remains the same as for the curved surface embodiment, but the rotary swing arm is replaced with a boom 16 that is capable of telescopic three-dimensional movement to permit the nozzle 2 to extend into areas which are difficult to access, while the nozzle 2 itself is mounted to the boom 16 in a manner to permit three-dimensional telescopic movement of the nozzle 2 independent of boom 16 movement. The positioning of the boom 16 and nozzle 2 can be adjusted independently of each other using pitch, yawl, roll and thrust functions to permit a complete three dimensional range of movement for cleaning or scarifying any surface. Additionally, movement of the boom 16 and nozzle 2 is fully adjustable so as to permit operation in a continuous or periodic reversible unidirectional or multidirectional manner over a full or limited range in such fashion as to permit stopping and restarting the boom 16 and nozzle 2 at any point along their travel. The movement of the boom 16 is preferably controlled by a source of power such as a hydraulic cylinder or motor which is operated independently from the nozzle 2 as described above for the swing arm/nozzle configuration of the curved surface embodiment. The carriage 6 is again a conventional design such as a manlift manufactured by JLG, Inc. that has a base with a swivel turret-type device to accommodate the boom 16. Again, the carriage 6, boom 16 and nozzle 2 movements and functions can be made automatic (such as through use of microprocessor or programmable logic circuit or relay logic circuit control) or can be remotely and/or manually controlled by the operator (including an override any of automatic functions), and are capable of infinitely variable adjustment while the machine is in use.

In embodiments of the invention designed for cleaning and scarifying flat surfaces such as that shown in FIG.(4), the design of the nozzle 2 again preferably remains the same as for the curved and three-dimensional surface embodiments, but the rotary swing arm or boom is replaced with a traverse beam 20/mast 21 arrangement that permits linear movement of the nozzle 2 to traverse the surface in one dimension of the surface plane while movement of the carriage 6 permits nozzle 2 movement in the other plane dimension. The orientation of the traverse beam 20/mast 21 can be adjusted to permit cleaning or scarifying horizontal or vertical surfaces and its movement is fully adjustable so as to permit operation in a continuous or periodic reversible manner over a full or limited range in such fashion as to permit stopping and restarting the traverse beam 20/mast 21 and nozzle 2 at any point along their travel. The movement of the traverse beam 20/mast 21 is again preferably controlled by a source of power such as a hydraulic cylinder or motor which is operated independently from the nozzle 2 as described above for the swing arm/nozzle configuration of the curved surface embodiment. The carriage 6 is again a conventional design such as a hoist manufactured by JLG, Inc.? that has a base to accommodate the traverse beam 20/mast 21 arrangement. The carriage 6, traverse beam 20/mast 21 and nozzle 2 movements and functions can again be made automatic or can be remotely and/or manually controlled by the operator (including an override any of automatic functions), and are capable of infinitely variable adjustment while the machine is in use.

While the invention has been described in connection with what are presently considered to be the preferred embodiments, it is to be understood the invention is not to be limited to the disclosed embodiments, but on the contrary is intended to cover various modifications and equivalent arrangements included within the spirit and scope of the appended claims.

What is claimed is:

1. An apparatus for fluidized cleaning or scarification of a surface wherein said apparatus comprises a moveable carriage for mounting an assembly which conveys an adjustable pressurized treatment fluid to contact the treated surface, wherein said assembly comprises:
A. a fully moveable single or multiple port spray nozzle for supplying the treatment fluid to the treated surface;
B. a swivel which directs the fluid to said nozzle as said swivel moves with said nozzle;
C. a drive mechanism for controlling movement of said nozzle wherein the operation of said drive mechanism is independent of delivery of the treatment fluid.

2. The apparatus of claim 1 wherein said nozzle receives treatment fluid from a source external to the apparatus.

3. The apparatus of claim 1 wherein said nozzle is fully adjustable as to the amount, rate or speed at which the treatment fluid is delivered.

4. The apparatus of claim 1 wherein said drive mechanism controls rotary movement of said nozzle.

5. The apparatus of claim 1 wherein said nozzle movement is capable of infinitely variable adjustment.

6. The apparatus of claim 1 wherein said nozzle movement is automatically controlled.

7. The apparatus of claim 1 wherein said nozzle movement is manually controlled.

8. The apparatus of claim 6 wherein said automatic control is accomplished by use of a microprocessor or a programmable logic circuit or a relay logic circuit.

9. The apparatus of claim 6 wherein said automatic control is manually overridden.

10. The apparatus of claim 1 wherein said apparatus further comprises a moveable swing arm for mounting said nozzle such that said swing arm rotates about an axis as said nozzle rotates around an axis of said swing arm

11. The apparatus of claim 10 wherein an adjustable counterweight is mounted opposite said swing arm balancing said rotation of said swing arm.

12. The apparatus of claim 10 wherein said swing arm movement is controlled hydraulically and is independent from the movement of said nozzle.

13. The apparatus of claim 10 wherein said swing arm is fully adjustable as to speed, amount and frequency of movement and can be operated in a continuous or periodic reversible manner over a full or limited arc so as to permit stopping and restarting said swing arm and nozzle at any location.

14. The apparatus of claim 13 wherein said swing arm movement is capable of infinitely variable adjustment.

15. The apparatus of claim 13 wherein said swing arm movement is automatically controlled.

16. The apparatus of claim 13 wherein said swing arm movement is manually controlled.

17. The apparatus of claim 15 wherein said automatic control is accomplished by use of a microprocessor or a programmable logic circuit or a relay logic circuit.

18. The apparatus of claim 15 wherein said automatic control is manually overridden.

19. The apparatus of claim 1 wherein said apparatus further comprises a telescopic boom for mounting said nozzle such that said boom and said nozzle are independently moveable in three-dimensions.

20. The apparatus of claim 19 wherein said boom movement is controlled hydraulically and is independent from the movement of said nozzle.

21. The apparatus of claim 19 wherein the locations of said boom and said nozzle are independently adjustable using pitch, yawl, roll or thrust functions.

22. The apparatus of claim 19 wherein movement of said boom and said nozzle are fully adjustable to permit operation in a continuous or periodic reversible unidirectional or multidirectional manner over a full or limited range so as to permit stopping and restarting said boom and nozzle at any location.

23. The apparatus of claim 22 wherein said boom movement is capable of infinitely variable adjustment.

24. The apparatus of claim 22 wherein said boom movement is automatically controlled.

25. The apparatus of claim 22 wherein said boom movement is manually controlled.

26. The apparatus of claim 24 wherein said automatic control is accomplished by use of a microprocessor or a programmable logic circuit or a relay logic circuit.

27. The apparatus of claim 24 wherein said automatic control is manu ally overridden.

28. The apparatus of claim 1 wherein said apparatus further comprises a mast assembly for mounting said nozzle such that said nozzle is linearly moveable on said mast assembly to traverse the surface in one dimension while movement of the carriage permits the nozzle to move in another surface dimension.

29. The apparatus of claim 28 wherein the orientation of said mast assembly and said nozzle are adjustable to permit use of said apparatus with horizontal or vertical surfaces.

30. The apparatus of claim 28 wherein said mast assembly movement is controlled hydraulically and is independent from the movement of said nozzle.

31. The apparatus of claim 28 wherein movement of said mast assembly and said nozzle are fully adjustable to permit operation in a continuous or periodic reversible manner over a full or limited range so as to permit stopping and restarting said mast assembly and nozzle at any location.

32. The apparatus of claim 31 wherein said mast assembly movement is capable of infinitely variable adjustment.

33. The apparatus of claim 31 wherein said mast assembly movement is automatically controlled.

34. The apparatus of claim 31 wherein said mast assembly movement is manually controlled.

35. The apparatus of claim 33 wherein said automatic control is accomplished by use of a microprocessor or a programmable logic circuit or a relay logic circuit.

36. The apparatus of claim 33 wherein said automatic control is manually overridden.

37. A method of using the apparatus of claim 1 to accomplish cleaning or scarification of a surface wherein said fluid comprises water.

38. A method of using the apparatus of claim 10 to accomplish cleaning or scarification of a curved surface wherein said fluid comprises water.

39. A method of using the apparatus of claim 19 to accomplish cleaning or scarification of a three-dimensional surface wherein said fluid comprises water.

40. A method of using the apparatus of claim 28 to accomplish cleaning or scarification of a flat surface wherein said fluid comprises water.
